(19) United States
(12) Patent Application Publication
(10) Pub. No.: US 2009/0179875 A1
(43) Pub. Date: Jul. 16, 2009

(54) Flat display and driving method thereof

(75) Inventors: Chung-Lung Li, Hsin-Chu (TW); Kuang-Hsiang Liu, Hsin-Chu (TW); Tsang-Hong Wang, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: AU OPTRONICS CORP., Hsin-Chu (TW)

(21) Appl. No.: 12/153,210

(22) Filed: May 15, 2008

(30) Foreign Application Priority Data
Jan. 16, 2008 (TW) 97101638

(51) Int. Cl. G06F 3/038

(52) U.S. Cl. 345/204

(57) ABSTRACT

A flat display includes a substrate, multiple data lines, multiple scan lines, a source driving unit and a gate driving unit. The substrate includes a pixel array. The data lines are electrically connected to the pixel array. The scan lines including p groups of scan lines are electrically connected to the pixel array, wherein p is a positive integer. Some of the scan lines in the same group are not adjacent to each other. The source driving unit is electrically connected to the data lines. The gate driving unit includes p shift register circuits respectively enabling the p groups of scan lines. In a first frame period, p groups of scan lines are enabled according to a first sequence of groups, and in a second frame period, p groups of scan lines are enabled according to a second sequence of groups which is different from the first sequence of groups.

This application claims the benefit of Taiwan application Serial No. 97101638, filed Jan. 16, 2008, the subject matter of which is incorporated herein by reference.

### BACKGROUND OF THE INVENTION

1. Field of the Invention

The invention relates in general to a flat display and a driving method thereof, and more particularly to a flat display capable of improving image display quality and a driving method thereof.

2. Description of the Related Art

With the rapid advance in flat display technology, a large variety of new technologies are developed and provided. In order to reduce the number of signal lines of an integrated circuit (IC) and save cost, some panel charging circuit structures are already provided in the area of technology where the invention belongs to. However, as the circuit layout in each pixel of the panel charging structures is different from the conventional circuit layout, various mura will occur to the frame image and affect the imaging quality.

FIG. 1 shows a perspective of a conventional LCD. As indicated in FIG. 1, LCD 100 includes a substrate (not illustrated in the diagram), multiple data lines S1˜Sm, multiple scan lines G1˜G2n, a source driving unit 110 and a gate driving unit 120, wherein m and n are positive integers. The substrate includes a pixel array. The pixel array includes multiple pixels P(x, y), wherein x and y are positive integers. Each pixel P(x, y) includes a transistor T.

Let the first row of pixels of the pixel array be taken for example. First, the scan line G1 is enabled, and the pixels P(1, 1), P(3, 1), P(5, 1), . . . , P(2m−1, 1) are charged. Next, the scan line G2 is enabled, and the pixels P(2, 1), P(4, 1), P(6, 1), . . . , P(2m, 1) are charged. Meanwhile, due to the capacitance coupling effect, the pixels P(1, 1), P(3, 1), P(5, 1), . . . , P(2m−1, 1) are affected by the capacitance coupling effect and change their pixel voltage levels. Thus, the charge coupling level for the pixels in odd-numbered columns and the charge coupling level for the pixels in even-numbered columns are inconsistent. Consequently, mura occurs along the vertical direction because the brightness of the image frame is not uniformed.

### SUMMARY OF THE INVENTION

The invention is directed to a flat display and a driving method thereof. Multiple scan lines of the flat display are divided into different groups. Then, in different frame periods, the scan lines of corresponding groups are respectively enabled by multiple shift register circuits according to different sequences of groups so as to reduce the occurrence of mura on image frame.

According to a first aspect of the present invention, a flat display including a substrate, multiple data lines, multiple scan lines, a source driving unit and a gate driving unit is provided. The substrate includes a pixel array. The data lines are electrically connected to the pixel array. The scan lines are electrically connected to the pixel array. The scan lines include multiple odd-numbered scan lines and multiple even-numbered scan lines. The source driving unit is electrically connected to the data lines. The gate driving unit includes a first shift register circuit and a second shift register circuit. The first shift register circuit is used for sequentially enabling the odd-numbered scan lines, and the second shift register circuit is used for sequentially enabling the even-numbered scan lines. In a first frame period, the odd-numbered scan lines are sequentially enabled prior to the even-numbered scan lines, and the odd-numbered scan lines and the even-numbered scan lines are alternately enabled. In a second frame period, the even-numbered scan lines are sequentially enabled prior to the odd-numbered scan lines, and the odd-numbered scan lines and the even-numbered scan lines are alternately enabled.

According to a second aspect of the present invention, a method for driving a flat display is provided. The flat display includes a substrate, multiple data lines, multiple scan lines, a source driving unit and a gate driving unit. The substrate includes a pixel array. The data lines and the scan lines are electrically connected to the pixel array. The scan lines include multiple odd-numbered scan lines and multiple even-numbered scan lines. The source driving unit is electrically connected to the data lines. The gate driving unit includes a first shift register circuit and a second shift register circuit. The first shift register circuit is used for sequentially enabling the odd-numbered scan lines, and the second shift register circuit is used for sequentially enabling the even-numbered scan lines. The method for driving the flat display includes the following steps: First, the odd-numbered scan lines and the even-numbered scan lines are alternately enabled in a first frame period, wherein the odd-numbered scan lines are sequentially enabled prior to the even-numbered scan lines. Next, the odd-numbered scan lines and the even-numbered scan lines are alternately enabled in a second frame period, wherein the even-numbered scan lines are sequentially enabled prior to the odd-numbered scan lines.

According to a third aspect of the present invention, a flat display including a substrate, multiple data lines, multiple scan lines, a source driving unit and a gate driving unit is provided. The substrate includes a pixel array. The data lines are electrically connected to the pixel array. The scan lines including p groups of scan lines electrically connected to the pixel array, wherein p is a positive integer. Some of scan lines in the same group are not adjacent to each other. The source driving unit is electrically connected to the data lines. The gate driving unit includes p shift register circuits respectively used for enabling p groups of scan lines. In a first frame period, p groups of scan lines are enabled according to a first sequence of groups, and in a second frame period, p groups of scan lines are enabled according to a second sequence of groups which is different from the first sequence of groups.

According to a fourth aspect of the present invention, a method for driving a flat display is provided. The flat display includes a substrate, multiple data lines, multiple scan lines, a source driving unit and a gate driving unit. The substrate includes a pixel array. The data lines and the scan lines are electrically connected to the pixel array. The scan lines include p groups of scan lines. Some of scan lines in the same group are not adjacent to each other, wherein p is a positive integer. The source driving unit is electrically connected to the data lines. The gate driving unit includes p shift register circuits respectively used for enabling p groups of scan lines. The method for driving a flat display includes the following steps: First, in a first frame period, p groups of scan lines are enabled according to a first sequence of groups. Next, in a second frame period, p groups of scan lines are enabled according to a second sequence of groups and the second sequence of groups is different from the first sequence of groups.

According to a fifth aspect of the present invention, a flat display including a substrate, multiple data lines, multiple scan lines, a source driving unit and a gate driving unit is provided. The substrate includes a pixel array. The data lines are electrically connected to the pixel array. The scan lines are electrically connected to the pixel array. The scan lines include multiple odd-numbered scan lines and multiple even-numbered scan lines. The source driving unit is electrically connected to the data lines. The gate driving unit includes a first shift register circuit and a second shift register circuit. The first shift register circuit is used for sequentially enabling the odd-numbered scan lines according to a first start pulse signal, a first clock pulse signal and a first delay clock pulse signal. The second shift register circuit is used for sequentially enabling the even-numbered scan lines according to a second start pulse signal, a second clock pulse signal and a second delay clock pulse signal. In a first frame period, the phases of the first start pulse signal, the first clock pulse signal and the first delay clock pulse signal are respectively earlier than that of the second start pulse signal, the second clock pulse signal and the second delay clock pulse signal. In a second frame period, the phases of the second start pulse signal, the second clock pulse signal and the second delay clock pulse signal are respectively earlier than that of the first start pulse signal, the first clock pulse signal and the first delay clock pulse signal.

The invention will become apparent from the following detailed description of the preferred but non-limiting embodiments. The following description is made with reference to the accompanying drawings.

### BRIEF DESCRIPTION OF THE DRAWINGS

FIG. 1 (PriorArt) shows a perspective of a conventional LCD;

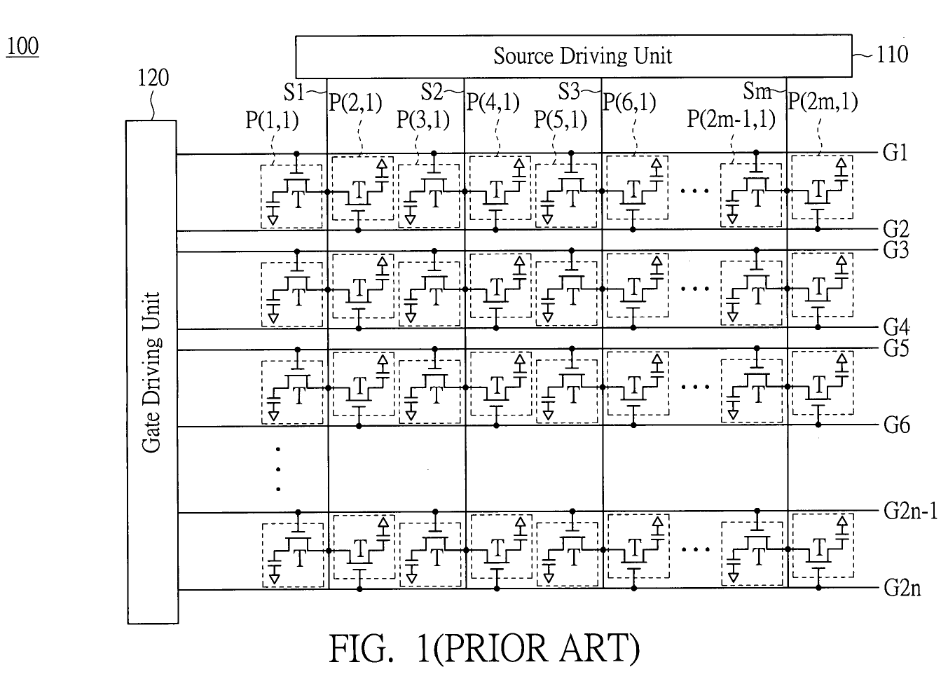

FIG. 2A shows a perspective of an LCD according to a first embodiment of the invention;

FIG. 2B is a signal wave pattern of driving shift registers according to the LCD of the first embodiment of the invention;

FIG. 2C is a signal wave pattern of driving scan lines according to the LCD of the first embodiment of the invention;

FIG. 2D is another signal wave pattern of driving shift registers according to the LCD of the first embodiment of the invention;

FIG. 2E is another signal wave pattern of driving scan lines according to the LCD of the first embodiment of the invention;

FIG. 3 shows a flowchart of a method for driving a flat display according to the LCD of the first embodiment of the invention;

FIG. 4A shows a perspective of an LCD according to a second embodiment of the invention;

FIG. 4B is a signal wave pattern of driving shift registers according to the LCD of the second embodiment of the invention;

FIG. 4C is a signal wave pattern of driving scan lines according to the LCD of the second embodiment of the invention;

FIG. 4D is another signal wave pattern of driving shift registers according to the LCD of the second embodiment of the invention;

FIG. 4E is another signal wave pattern of driving scan lines according to the LCD of the second embodiment of the invention; and

FIG. 5 shows a flowchart of a method for driving a flat display according to the LCD of the second embodiment of the invention.

### DETAILED DESCRIPTION OF THE INVENTION

A flat display and a driving method thereof are disclosed in the invention. Multiple scan lines of the flat display are divided into different groups. Next, in different frame periods, the scan lines of corresponding groups are respectively and sequentially enabled by the shift register circuits in the gate driving unit according to different sequences of groups. The flat display in the embodiments of the invention is exemplified as a liquid crystal display (LCD). However, the flat display is not limited to an LCD in the invention, and other types of displays would also do.

### First Embodiment

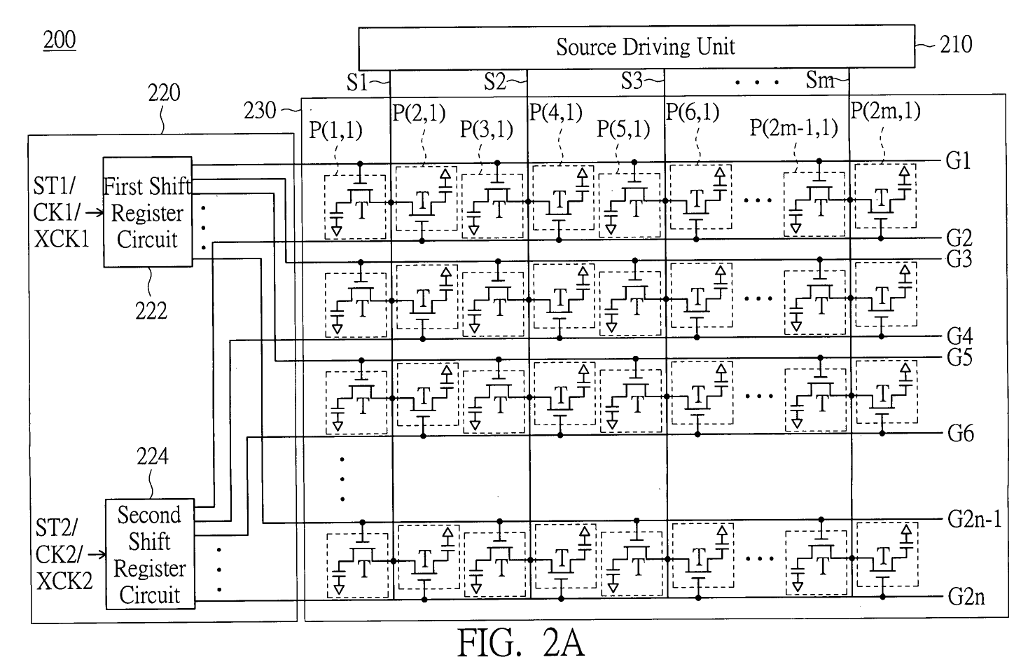

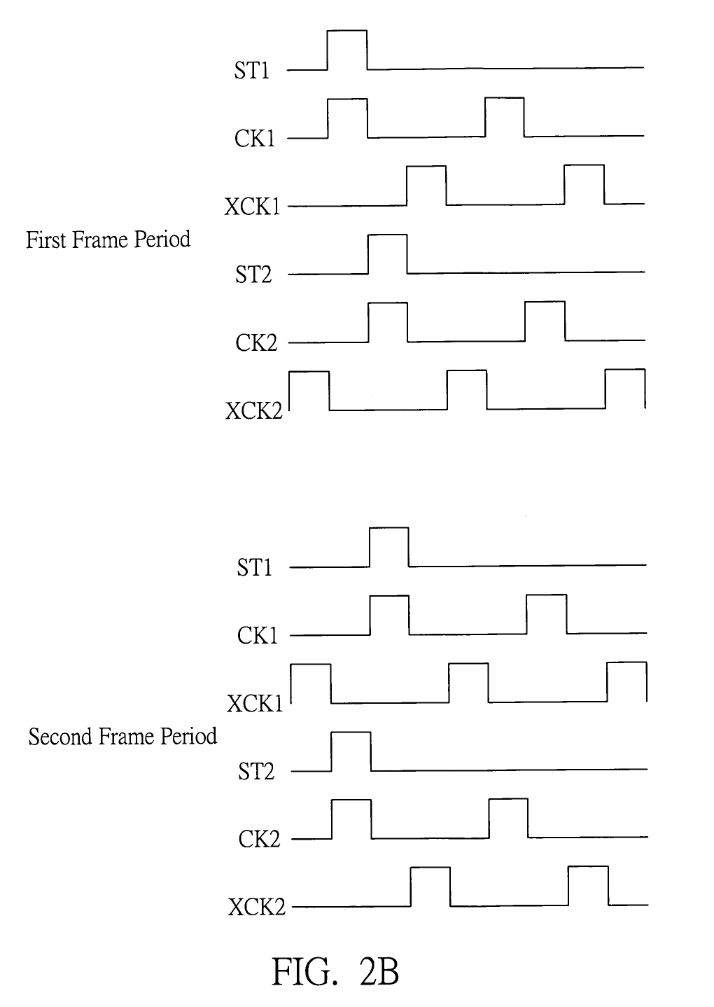

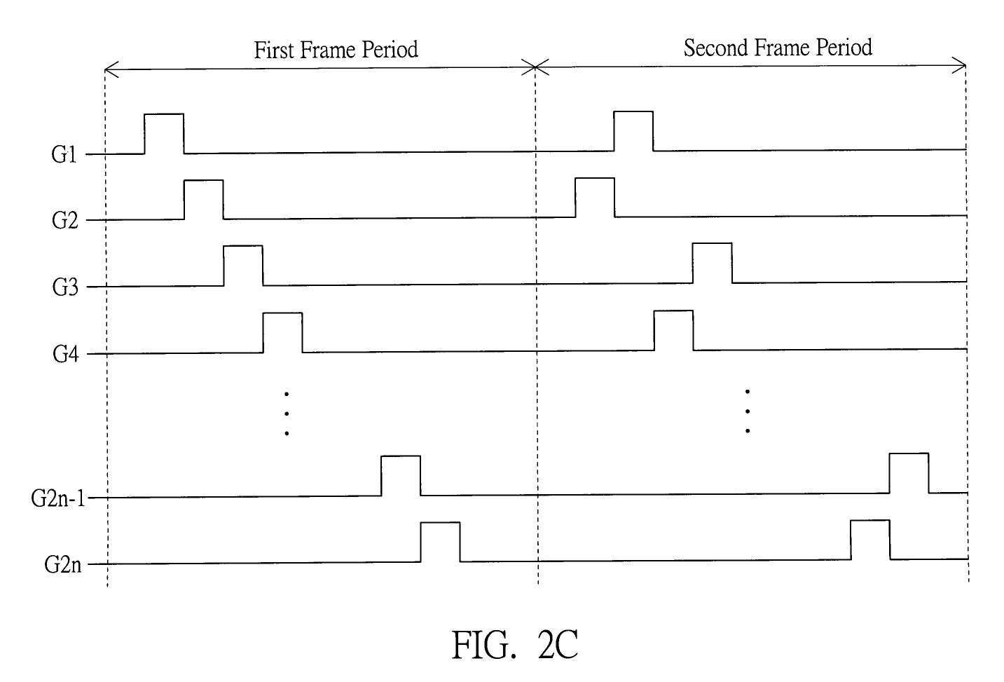

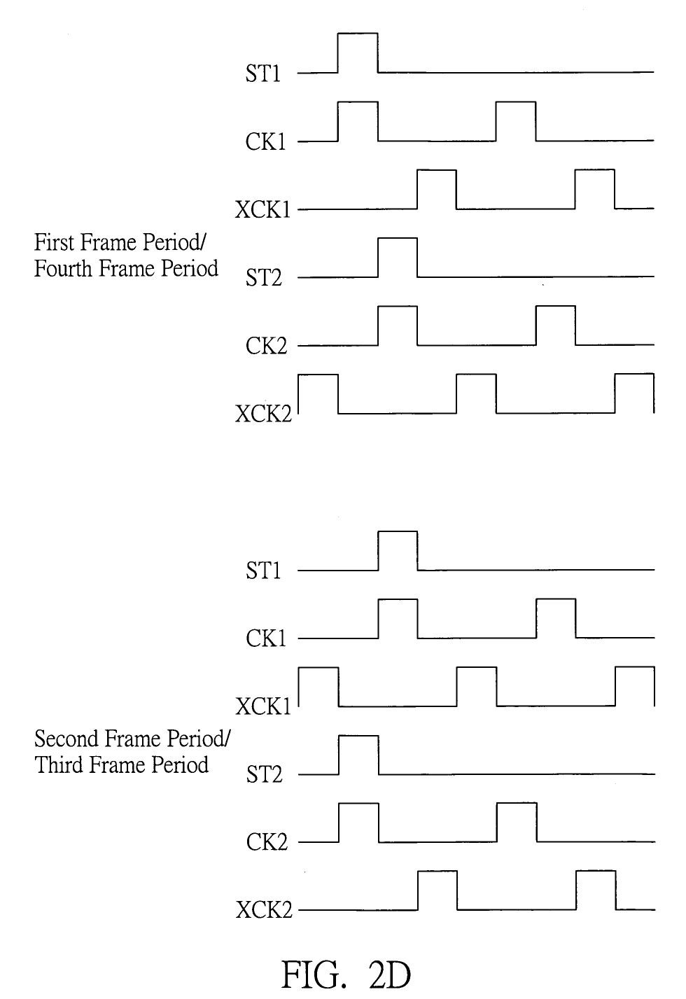

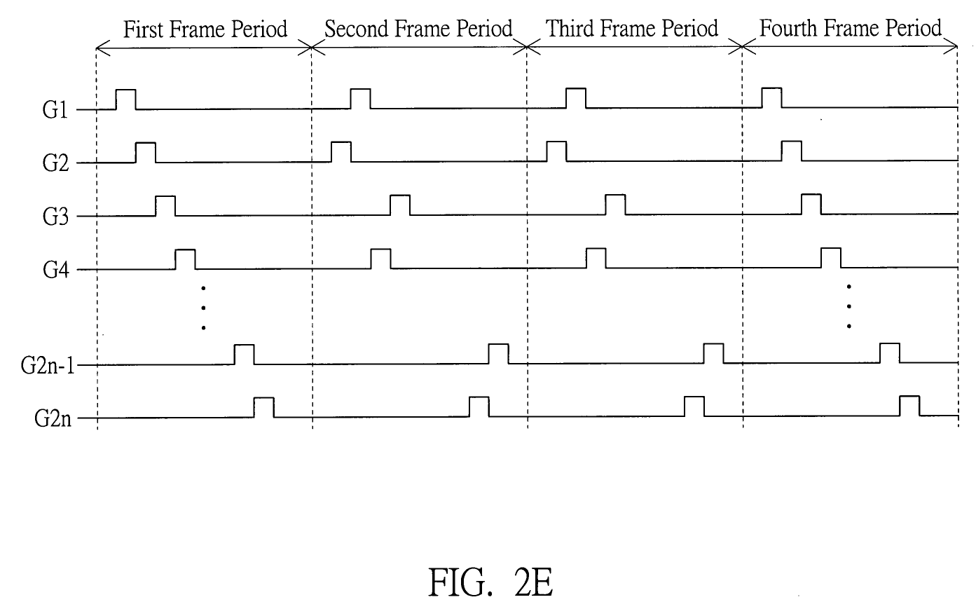

FIG. 2A shows a perspective of an LCD according to a first embodiment of the invention. As indicated in FIG. 2A, LCD 200 includes a substrate (not illustrated in the diagram), multiple data lines S1˜Sm, multiple scan line G1˜G2n, a source driving unit 210 and a gate driving unit 220, wherein m and n are positive integers. The substrate, for example, is a glass substrate including a pixel array 230. The pixel array 230 includes multiple pixels P(x, y), wherein x and y are positive integers, and each pixel includes a transistor T. On the part of the flat display 200, each of the data lines S1˜Sm, for example, is electrically connected to two transistors of two adjacent pixels in each row.

The data lines S1˜Sm are electrically connected to the pixel array 230. The scan line G1˜G2n are electrically connected to the pixel array 230. The scan lines G1˜G2n include multiple odd-numbered scan lines G1, G3, G5, . . . , G2n−1 and multiple even-numbered scan lines G2, G4, G6, . . . , G2n. The source driving unit 210 are electrically connected to the data lines S1˜Sm.

The gate driving unit 220 can be disposed on the substrate or directly formed on the substrate. The gate driving unit 220 includes a first shift register circuit 222 and a second shift register circuit 224. The first shift register circuit 222 is used for sequentially enabling odd-numbered scan lines G1, G3, G5, . . . , G2n−1 according to a first start pulse signal ST1, a first clock pulse signal CK1 and a first delay clock pulse signal XCK1, wherein the phase of the first delay clock pulse signal XCK1 is delayed by 180 degrees relative to that of the first clock pulse signal CK1. The second shift register circuit 224 is used for sequentially enabling even-numbered scan lines G2, G4, G6, . . . , G2n according to a second start pulse signal ST2, a second clock pulse signal CK2 and a second delay clock pulse signal XCK2, wherein the phase of the second delay clock pulse signal XCK2 is delayed by 180 degrees relative to that of the second clock pulse signal CK2.

FIG. 2B is a signal wave pattern of driving shift registers according to the LCD of the first embodiment of the invention. As indicated in FIG. 2B, by changing the sequence of the control signals ST1/CK1/XCK1 and ST2/CK2/XCK2, the scan lines of corresponding groups are respectively enabled according to different sequences of groups. For example, as indicated in FIG. 2B, in the first frame period, the phases of the control signals ST1/CK1/XCK1 are respectively earlier than that of the control signal ST2/CK2/XCK2; in the second frame period, the phases of the control signals ST2/CK2/XCK2 are respectively earlier than that of the control signal ST1/CK1/XCK1. Thus, the shift register circuits can use the same circuit so as to simplify the gate driving unit structure and reduce the cost.

FIG. 2C is a signal wave pattern of driving scan lines according to the LCD of the first embodiment of the invention. As indicated in FIG. 2C, in a first frame period, the odd-numbered scan lines G1, G3, G5, . . . , G2n−1 and the even-numbered scan lines G2, G4, G6, . . . , G2n are alternately enabled. That is, the scan lines G1, G2, G3, G4, . . . , G2n−1 and G2n are sequentially enabled.

In a second frame period, the scan lines G2, G1, G4, G3, . . . , G2n and G2n−1 are sequentially enabled. As the odd-numbered scan lines G1, G3, G5, . . . , G2n−1 and the even-numbered scan lines G2, G4, G6, . . . , G2n are enabled according to different sequence of groups in different frame periods, and the charge coupling level for each pixel is approximately the same. Consequently, the overall brightness is more uniformed and the occurrence of mura on an image frame is reduced.

Let the first row of pixels of the pixel array 230 be taken for example. In the first frame period, when the scan line G1 is enabled, the pixels P(1, 1), P(3, 1), P(5, 1), . . . , P(2m−1, 1) are charged. Meanwhile, the voltages of the pixels P(2, 1), P(4, 1), P(6, 1), . . . , P(2m, 1) also change due to the capacitance coupling effect. Then, the scan line G2 is enabled, the pixels P(2, 1), P(4, 1), P(6, 1), . . . , P(2m, 1) are charged, and the voltages of the pixels P(2, 1), P(4, 1), P(6, 1), . . . , P(2m, 1) are updated so as to eliminate the capacitance coupling effect incurring when the scan line G1 is enabled. However, when the scan line G2 is enabled, the received voltages of the pixels P(1, 1), P(3, 1), P(5, 1), . . . , P(2m−1, 1) will change due to the capacitance coupling effect and remain for a frame period.

In a second frame period, when the scan line G2 is enabled, the pixels P(2, 1), P(4, 1), P(6, 1), . . . , P(2m, 1) are charged, the voltages of the pixels P(1, 1), P(3, 1), P(5, 1), . . . , P(2m−1, 1) also change due to the capacitance coupling effect. Then, the scan line G1 is enabled, the pixels P(1, 1), P(3, 1), P(5, 1), . . . , P(2m−1, 1) are charged, and the voltages of the pixel P(1, 1), P(3, 1), P(5, 1), . . . , P(2m−1, 1) are updated so as to eliminate the capacitance coupling effect incurring when the scan line G2 is enabled. However, when the scan line G1 is enabled, the received voltages of the pixels P(2, 1), P(4, 1), P(6, 1), . . . , P(2m, 1) will change due to the capacitance coupling effect and remain for a frame period.

According to the above disclosure, the pixels in the odd-numbered columns P(1, 1), P(3, 1), P(5, 1), . . . , P(2m−1, 1) are affected by the capacitance coupling effect in the first frame period, and the pixels in the even-numbered columns P(2, 1), P(4, 1), P(6, 1), . . . , P(2m, 1) are affected by the capacitance coupling effect in the second frame period. Therefore, after the first frame period and the second frame period, the first row of pixels P(1, 1)˜P(2m, 1) are affected by the charging coupling effect to much the same level. Likewise, the pixels in other rows are affected by the capacitance coupling effect to much the same level with the first row of pixels. Thus, the user will not sense the mura caused by the difference in brightness when the capacitance coupling effect varies with the columns.

On the part of the conventional LCD 100, when the scan line G1 is enabled, the voltages of the pixels P(2, 1), P(4, 1), P(6, 1), . . . , P(2m, 1) are changed due to the capacitance coupling effect; when the scan line G2 is enabled, the voltages of the pixels P(2, 1), P(4, 1), P(6, 1), . . . , P(2m, 1) are updated so as to eliminate the capacitance coupling effect but the voltages of the pixels P(1, 1), P(3, 1), P(5, 1), . . . , P(2m−1, 1) are changed due to the capacitance coupling effect and remain for a frame period. In the conventional LCD 100, only the voltages of the pixels in odd-numbered columns affected by the capacitance coupling effect will remain for an overall frame period, so the pixels in odd-numbered columns will have color shift and result in mura along the vertical direction of the LCD 100. However, in the present embodiment of the invention, as the pixels in each column of the LCD 200 are affected by the charging coupling effect to much the same level, there is no mura along the vertical direction.

Besides, the sequence of enabling the odd-numbered scan lines and the even-numbered scan lines can be changed in every one, two or multiple adjacent frame periods and is not limited thereto.

FIG. 2D is another signal wave pattern of driving shift registers according to the LCD of the first embodiment of the invention. The wave patterns of the control signals ST1/CK1/XCK1 and ST2/CK2/XCK2 substantially similar to that of FIG. 2B are changed in every two frame periods.

FIG. 2E is another signal wave pattern of driving scan lines according to the LCD of the first embodiment of the invention. The first, the second, the third and the fourth frame periods are adjacently arranged in sequence. In the first frame period, the scan lines G1, G2, G3, G4, . . . , G2n−1 and G2n are sequentially enabled. Next, in the second frame period and the third frame period, the scan lines G2, G1, G4, G3, . . . , G2n and G2n−1 are sequentially enabled. Then, in the fourth frame period, the scan lines G1, G2, G3, G4, . . . , G2n−1 and G2n are sequentially enabled.

Moreover, as indicated in FIG. 2A, the LCD 200 can also respectively and sequentially enable the scan lines of corresponding groups according to multiple different sequences of groups by way of controlling the start pulse signal, the clock pulse signal and the delay clock pulse signal received by the gate driving unit 220 or other methods, and the invention is not limited thereto.

The invention also discloses a method for driving a flat display. The flat display includes a substrate, multiple data lines, multiple scan lines, a source driving unit and a gate driving unit. The substrate, for example, is a glass substrate including a pixel array. The pixel array includes multiple pixels. Each pixel includes a transistor, and each data line is electrically connected to two transistors of two adjacent pixels in each row.

The data lines and scan lines are electrically connected to the pixel array. The scan lines include multiple odd-numbered scan lines and multiple even-numbered scan lines. The source driving unit is electrically connected to the data lines. The gate driving unit can be disposed on the substrate or directly formed on the substrate. The gate driving unit includes a first shift register circuit and a second shift register circuit. The first shift register circuit is used for sequentially enabling odd-numbered scan lines. The second shift register circuit is used for sequentially enabling even-numbered scan lines.

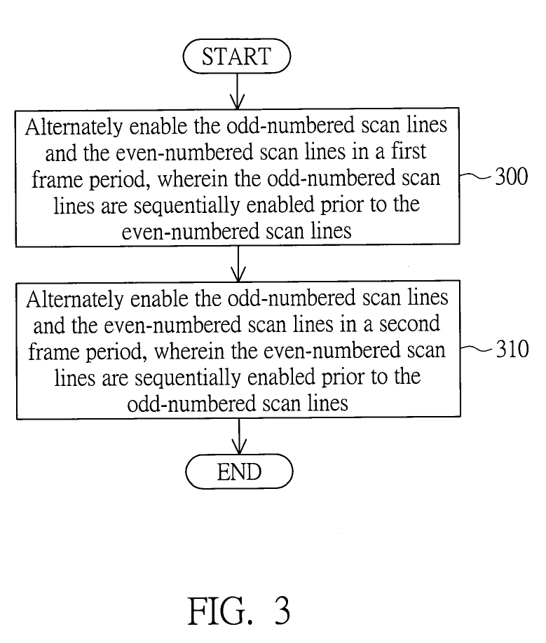

FIG. 3 shows a flowchart of a method for driving a flat display according to the LCD of the first embodiment of the invention. First, the method begins at step 300, in a first frame period, multiple odd-numbered scan lines and multiple even-numbered scan lines are alternately enabled, wherein the odd-numbered scan lines are sequentially enabled prior to the even-numbered scan lines. Next, the method proceeds to step 310, in a second frame period, multiple odd-numbered scan lines and multiple even-numbered scan lines are alternately enabled, wherein the even-numbered scan lines are sequentially enabled prior to the odd-numbered scan lines.

The operating principles of the method for driving a flat display are disclosed in the elaboration of the LCD 200 and are not repeated here again.

### Second Embodiment

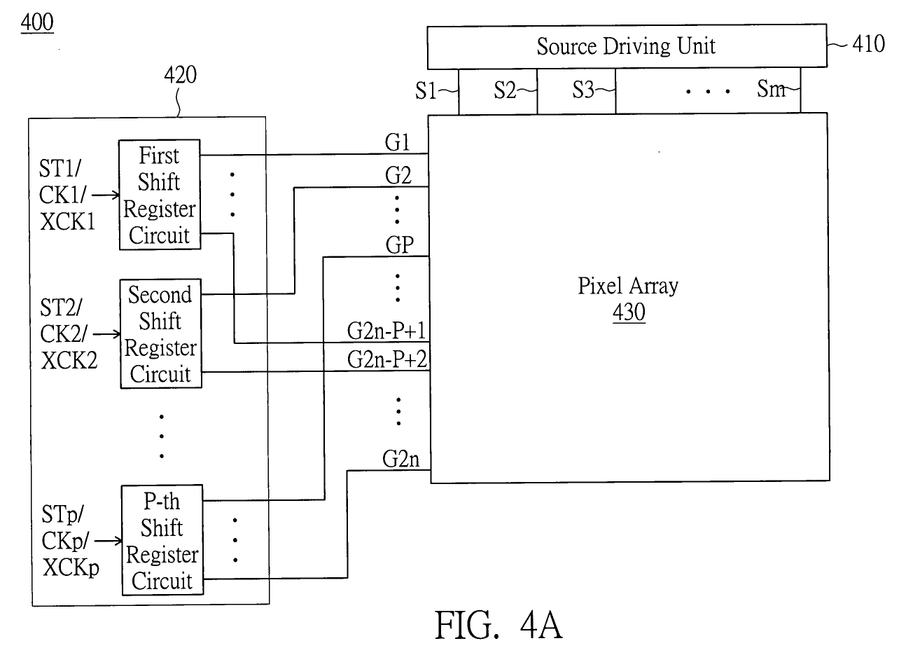

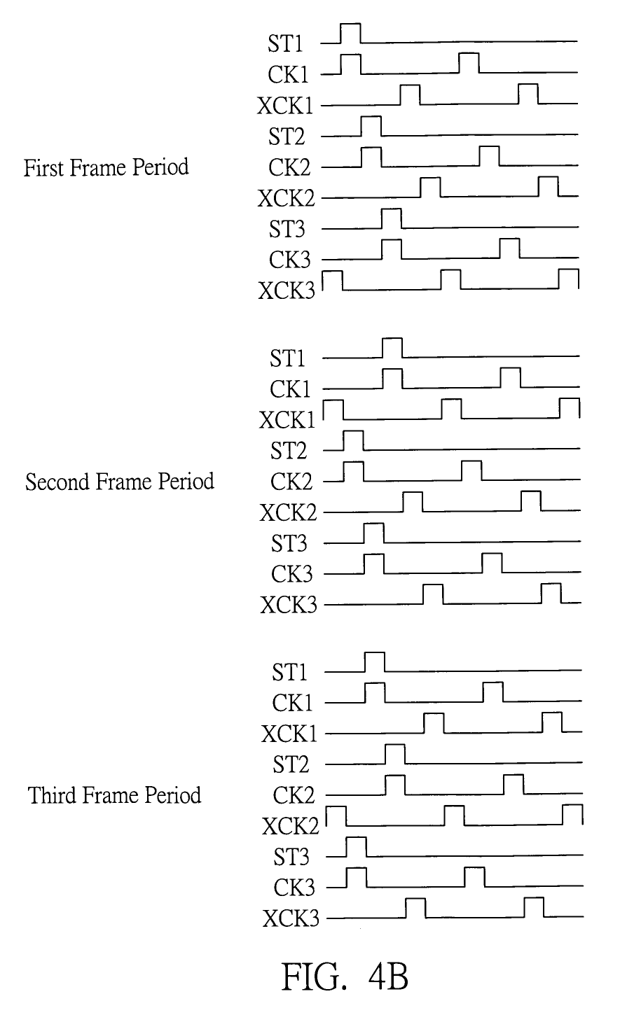

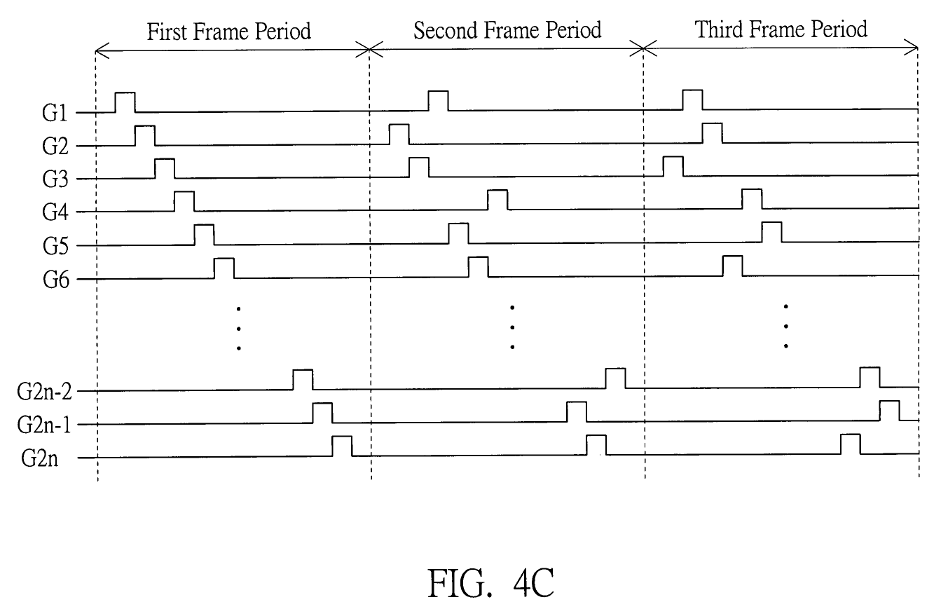

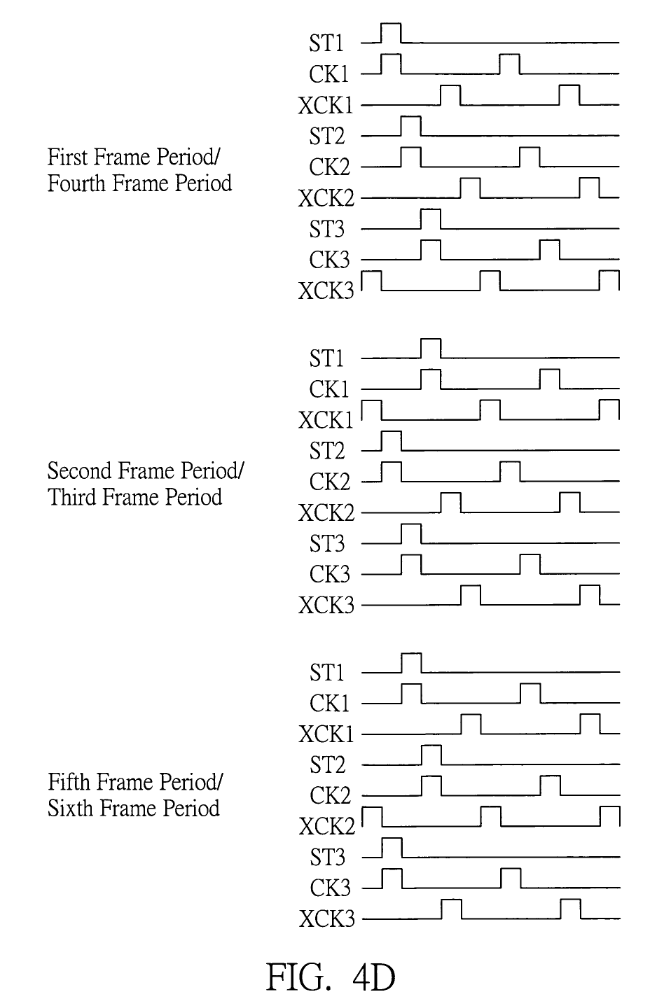

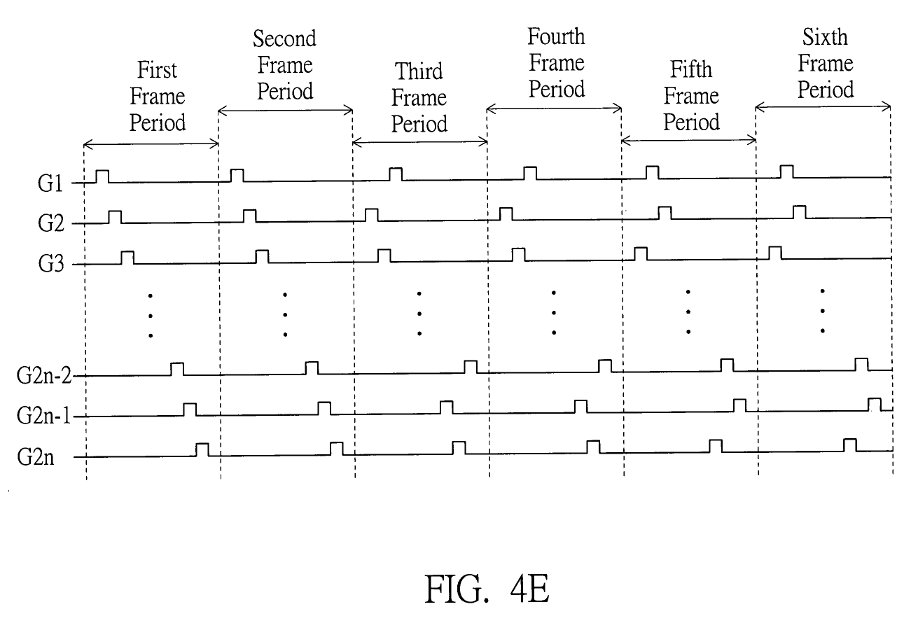

FIG. 4A shows a perspective of an LCD according to a second embodiment of the invention. The LCD 400 includes a substrate (not illustrated in the diagram), multiple data lines S1˜Sm, multiple scan lines G1˜G2n, a source driving unit 410 and a gate driving unit 420, wherein m and n are positive integers. The substrate, for example, is a glass substrate including a pixel array 430. The pixel array 430 includes multiple pixels, and each pixel includes a transistor (not illustrated in the diagram). In the LCD 400, each data line S1˜Sm, for example, is electrically connected to p transistors of the pixels in each row, wherein p is a positive integer.

The multiple data lines S1˜Sm are electrically connected to the pixel array 430. The multiple scan lines G1˜G2n are electrically connected to the pixel array 430. The scan lines G1˜G2n include p groups of scan lines, wherein some of the scan lines are not adjacent to each other. The source driving unit 410 is electrically connected to the data lines S1˜Sm. The gate driving unit 420 includes a first shift register circuit 421 to a p-th shift register circuit 42p respectively used for enabling p groups of scan lines.

In a first frame period, p groups of scan lines are enabled according to a first sequence of groups. Next, in a second frame period following the first frame period, p groups of scan lines are enabled according to a second sequence of groups different from the first sequence of groups. Or, in a third frame period following the second frame period, p groups of scan lines are enabled according to a third sequence of groups different from the first and the second sequences of groups. Besides, the sequence of enabling the p groups of scan lines can also be changed in every adjacent multiple frame periods.

In the disclosure below, p is exemplified as 3. Referring to FIG. 4B and FIG. 4C, FIG. 4B is a signal wave pattern of driving shift registers according to the LCD of the second embodiment of the invention. FIG. 4C is a signal wave pattern of driving scan lines according to the LCD of the second embodiment of the invention. In the first frame period, three shift register circuits sequentially enable three groups of scan lines in the order of the first group, the second group and the third group. Next, in the second frame period following the first frame period, the three shift register circuits sequentially enable the three groups of scan lines in the order of the second group, the third group and the first group. In the third frame period following the second frame period, the three shift register circuits sequentially enable the three groups of scan lines in the order of the third group, the first group and the second group. Despite p is exemplified as 3 in the present embodiment of the invention, the invention is not limited thereto, and p can also be exemplified as other positive integers. Also, the sequence of enabling the scan lines in a frame period can be changed and is not limited to the sequence disclosed above.

Also, the sequence of enabling different groups of scan lines can also be changed in every two adjacent frame periods. Referring to FIG. 4D and FIG. 4E, FIG. 4D is another signal wave pattern of driving shift registers according to the LCD of the second embodiment of the invention, and FIG. 4E is another signal wave pattern of driving scan lines according to the LCD of the second embodiment of the invention. In the first frame period and the second frame period adjacent to the first frame period, the three shift register circuits sequentially enable three groups of scan lines in the order of the first group, the second group and the third group. Next, following the second frame period, in the third frame period and the fourth frame period adjacent to the third frame period, the three shift register circuits sequentially enable the three groups of scan lines in the order of the second group, the third group and the first group. Following the fourth frame period, in the fifth frame period and the sixth frame period adjacent to the fifth frame period, the three shift register circuits sequentially enable the three groups of scan lines in the order of the third group, the first group and the second group.

The operating principles of LCD 400 are similar to that of the LCD 200 and are not repeated here.

The invention also discloses another method for driving a flat display. The flat display includes a substrate, multiple data lines, multiple scan lines, a source driving unit and a gate driving unit. The substrate includes a pixel array. The multiple data lines and the multiple scan lines are electrically connected to the pixel array. The scan lines includes p groups of scan lines, and some of the scan lines in the same group are not adjacent to each other, wherein p is a positive integer. The source driving unit is electrically connected to the data lines. The gate driving unit includes p shift register circuits respectively used for enabling p groups of scan lines.

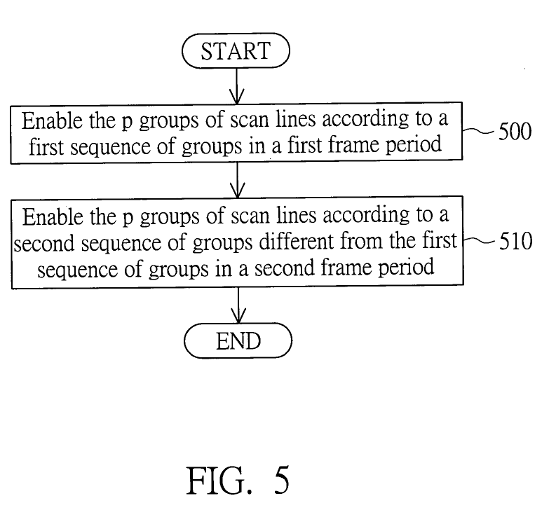

FIG. 5 shows a flowchart of a method for driving a flat display according to the LCD of the second embodiment of the invention. First, the method begins at step 500, in a first frame period, p groups of scan lines are enabled according to a first sequence of groups. Next, the method proceeds to step 520, in a second frame period, p groups of scan lines are enabled according to a second sequence of groups and the second sequence of groups is different from the first sequence of groups.

The operating principles of the method for driving a flat display are disclosed in the elaboration of the LCD 400 and are not repeated here.

Besides, the enabling time of the pulse of the control signals ST1/CK1/XCK1 can be overlapped with the enabling time of the pulse of the control signals ST2/CK2/XCK2 so that the pulses of the scan signals of adjacent scan lines will be partly overlapped accordingly. Thus, the pixels in the pixel array have pre-charging time for allowing each pixel to promptly display the desired brightness, so the LCD 200 or 400 can have higher brightness.

According to the flat display and the driving method thereof disclosed in the above embodiments of the invention, multiple scan lines of the flat display are divided into different groups according to the charging circuit structure of the pixel array of the flat display, and multiple shift register circuits are disposed in the gate driving unit. Thus, in different frame periods, the shift register circuits of the gate driving unit sequentially enable the scan lines of corresponding groups according to different sequences of groups so that the charge coupling level of each pixel is approximately the same. As the influence of the capacitance coupling effect on each pixel is more uniformed in the invention than in the conventional method, the occurrence of mura on an image frame is effectively reduced.

Moreover, the shift register circuits can use the same circuit, and the above effect can be achieved by way of changing the time sequence of the clock pulse signal and the start pulse signal which control the shift register circuits. Thus, the invention further has the advantages of simple hardware design of the circuit, simple control signals, and effective cost down.

Despite the invention is disclosed above in two preferred embodiments, the above disclosures are not for limiting the scope of protection of the invention.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flat display, comprising:
a substrate comprising a pixel array;
a plurality of data lines electrically connected to the pixel array;
a plurality of scan lines electrically connected to the pixel array, wherein the scan lines comprise a plurality of odd-numbered scan lines and a plurality of even-numbered scan lines;
a source driving unit electrically connected to the data lines; and
a gate driving unit comprising a first shift register circuit and a second shift register circuit, wherein the first shift register circuit is used for sequentially enabling the odd-numbered scan lines, and the second shift register circuit is used for sequentially enabling the even-numbered scan lines;
wherein, in a first frame period, the odd-numbered scan lines are sequentially enabled prior to the even-numbered scan lines, and the odd-numbered scan lines and the even-numbered scan lines are alternately enabled;
wherein, in a second frame period, the even-numbered scan lines are sequentially enabled prior to the odd-numbered scan lines, and the odd-numbered scan lines and the even-numbered scan lines are alternately enabled.

2. The flat display according to claim 1, wherein the scan lines comprise the first, the second, . . . , and the 2n-th scan lines, in the first frame period, the first, the second, . . . , the (2n−1)-th and the 2n-th scan lines are sequentially enabled, and in the second frame period, the second, the first, . . . the 2n-th, and the (2n−1)-th scan lines are sequentially enabled.

3. The flat display according to claim 1, wherein in a third frame period, the even-numbered scan lines are sequentially enabled prior to the odd-numbered scan lines, the odd-numbered scan lines and the even-numbered scan lines are alternately enabled, in a fourth frame period, the odd-numbered scan lines are sequentially enabled prior to the even-numbered scan lines, the odd-numbered scan lines and the even-numbered scan lines are alternately enabled, and the first, the second, the third, and the fourth frame periods are adjacent to one another and arranged in sequence.

4. The flat display according to claim 1, wherein the pixel array comprises a plurality of pixels, each pixel comprises a transistor, and each data line is electrically connected to two transistors of two adjacent pixels in each row.

5. A method for driving a flat display, wherein the flat display comprises a substrate, a plurality of data lines, a plurality of scan lines, a source driving unit and a gate driving unit, the substrate comprises a pixel array, the data lines and the scan lines are electrically connected to the pixel array, the scan lines comprise a plurality of odd-numbered scan lines and a plurality of even-numbered scan lines, the source driving unit is electrically connected to the data lines, the gate driving unit comprises a first shift register circuit and a second shift register circuit, the first shift register circuit is used for sequentially enabling the odd-numbered scan lines, the second shift register circuit is used for sequentially enabling the even-numbered scan lines, the method for driving the flat display comprises:
alternately enabling the odd-numbered scan lines and the even-numbered scan lines in a first frame period, wherein the odd-numbered scan lines are sequentially enabled prior to the even-numbered scan lines; and
alternately enabling the odd-numbered scan lines and the even-numbered scan lines in a second frame period, wherein the even-numbered scan lines are sequentially enabled prior to the odd-numbered scan lines.

6. The method for driving a flat display according to claim 5, wherein the scan lines comprise the first, the second, . . . , and the 2n-th scan lines, in the first frame period, the first, the second, . . . , the (2n−1)-th and the 2n-th scan lines are sequentially enabled, and in the second frame period, the second, the first, . . . the 2n-th and the (2n−1)-th scan lines are sequentially enabled.

7. The method for driving a flat display according to claim 5, further comprising:
alternately enabling the odd-numbered scan lines and the even-numbered scan lines in a third frame period, wherein the even-numbered scan lines are sequentially enabled prior to the odd-numbered scan lines; and
alternately enabling the odd-numbered scan lines and the even-numbered scan lines in a fourth frame period, wherein the odd-numbered scan lines are sequentially enabled prior to the even-numbered scan lines;
wherein the first, the second, the third, and the fourth frame periods are arranged in sequence.

8. The method for driving a flat display according to claim 5, wherein the pixel array comprises a plurality of pixels, each pixel comprises a transistor, and each data line is electrically connected to two transistors of two adjacent pixels in each row.

9. A flat display, comprising:
a substrate comprising a pixel array;
a plurality of data lines electrically connected to the pixel array;
a plurality of scan lines comprising p groups of scan lines electrically connected to the pixel array, wherein some of the scan lines in the same group are not adjacent to each other, and p is a positive integer;
a source driving unit electrically connected to the data lines; and
a gate driving unit comprising p shift register circuits respectively used for enabling the p groups of scan lines;
wherein, the p groups of scan lines are enabled according to a first sequence of groups in a first frame period, and the p groups of scan lines are enabled according to a second sequence of groups in a second frame period, and wherein the second sequence of groups is different from the first sequence of groups.

10. The flat display according to claim 9, wherein the first frame period and the second frame period are arranged in sequence.

11. The flat display according to claim 9, wherein the sequence for enabling the p groups of scan lines does not change in every two adjacent frame periods.

12. The flat display according to claim 9, wherein the sequence for enabling the p groups of scan lines of two adjacent frame periods does not change.

13. The flat display according to claim 9, wherein the pixel array comprises a plurality of pixels, each pixel comprises a transistor, and each data line is electrically connected to p transistors of the pixels in each row.

14. A method for driving a flat display, wherein the flat display comprises a substrate, a plurality of data lines, a plurality of scan lines, a source driving unit and a gate driving unit, the substrate comprises a pixel array, the data lines and the scan lines are electrically connected to the pixel array, the scan lines comprise p groups of scan lines, some of the scan lines in the same group are not adjacent to each other, p is a positive integer, the source driving unit is electrically connected to the data lines, the gate driving unit comprises p shift register circuits respectively used for enabling the p groups of scan lines, the method for driving the flat display comprises:
enabling the p groups of scan lines according to a first sequence of groups in a first frame period; and
enabling the p groups of scan lines according to a second sequence of groups in a second frame period, wherein the second sequence of groups is different from the first sequence of groups.

15. The method for driving a flat display according to claim 14, wherein the first frame period and the second frame period are arranged in sequence.

16. The method for driving a flat display according to claim 14, wherein the sequence for enabling the p groups of scan lines does not change in every two adjacent frame periods.

17. The flat display according to claim 14, wherein the sequence for enabling the p groups of scan lines of two adjacent frame periods does not change.

18. The method for driving a flat display according to claim 14, wherein the pixel array comprises a plurality of pixels, each pixel comprises a transistor, and each data line is electrically connected to p transistors of the pixels in each row.

19. The method for driving a flat display according to claim 14, further comprising:
enabling the p groups of scan lines according to a third sequence of groups in a third frame period, wherein the third sequence of groups is different from the first and the second sequences of groups.

20. A flat display, comprising:
a substrate comprising a pixel array;
a plurality of data lines electrically connected to the pixel array;
a plurality of scan lines electrically connected to the pixel array, wherein the scan lines comprise a plurality of odd-numbered scan lines and even-numbered scan lines;
a source driving unit electrically connected to the data lines; and
a gate driving unit comprising a first shift register circuit and a second shift register circuit, wherein the first shift register circuit is used for sequentially enabling the odd-numbered scan lines according to a first start pulse signal, a first clock pulse signal and a first delay clock pulse signal, and the second shift register circuit is used for sequentially enabling the even-numbered scan lines according to a second start pulse signal, a second clock pulse signal and a second delay clock pulse signal;
wherein, in a first frame period, the phases of the first start pulse signal, the first clock pulse signal and the first delay clock pulse signal are respectively earlier than that of the second start pulse signal, the second clock pulse signal and the second delay clock pulse signal;
wherein, in a second frame period, the phases of the second start pulse signal, the second clock pulse signal and the second delay clock pulse signal are respectively earlier than that of the first start pulse signal, the first clock pulse signal and the first delay clock pulse signal.

21. The flat display according to claim 20, wherein the phase of the first delay clock pulse signal is shifted by 180 degrees relative to the phase of the first clock pulse signal, and the phase of the second delay clock pulse signal is shifted by 180 degrees relative to the phase of the second clock pulse signal.
